(19) United States
(12) Patent Application Publication
(10) Pub. No.: US 2009/0180735 A1
(43) Pub. Date: Jul. 16, 2009

(54) Integrated light source and optical waveguide and method

(76) Inventor: Ju Gao, Champaign, IL (US)

Correspondence Address: DUANE MORRIS LLP - DC, 505 9th Street, Suite 1000, WASHINGTON, DC, 20004-2166, US

(21) Appl. No.: 12/382,548

(22) Filed: Mar. 18, 2009

Related U.S. Application Data
(63) Continuation of application No. 10/949,196, filed on Sep. 27, 2004, now abandoned.
(60) Provisional application No. 60/505,429, filed on Sep. 25, 2003.
(60) Provisional application No. 60/524,612, filed on Nov. 25, 2003.

(51) Int. Cl. G02B 6/42

(52) U.S. Cl. 385/31

(57) ABSTRACT

An optical system and method including an integrated light source and optical waveguide that relies on internal reflection for coupling the light emitted from the source to the waveguide. The light source may include electroded or electrodeless plasma lamps, LEDs, and filament lamps. The optical waveguide may be shaped to form a compound parabolic waveguide. A system may also include an integrated light source, microwave waveguide, and optical coupler.

### CLAIM OF PRIORITY

This application claims the filing date priority of U.S. Provisional Patent Application No. 60/505,429 filed Sep. 25, 2003, U.S. Provisional Patent Application No. 60/524,612 filed Nov. 25, 2003, and U.S. patent application Ser. No. 10/949,196 filed Sep. 27, 2004. The contents of each application is incorporated herein by reference.

### BACKGROUND OF THE INVENTION

The present invention relates generally to the coupling of electromagnetic waves into an electromagnetic waveguide, and particularly to the coupling of light (visible and/or non-visible) from a source into an optical waveguide.

Distributed lighting systems are well known and include a light source, optical waveguide and a coupler for coupling the light from the source into the waveguide. Examples of optical waveguides include light pipes and optical fibers. In a conventional system, the coupler is a reflector shaped to change the direction of incident light rays, and the complexity thereof has limited the effectiveness of distributed light systems. The shape of the reflecting surface of the coupler may be parabolic or compound parabolic. One efficient arrangement for coupling light from a source to a waveguide using a compound parabolic coupler (“CPC”) is disclosed and claimed in the Buelow et al. U.S. Pat. No. 6,304,693 dated Oct. 16, 2001.

### DETAILED DESCRIPTION OF THE DRAWINGS

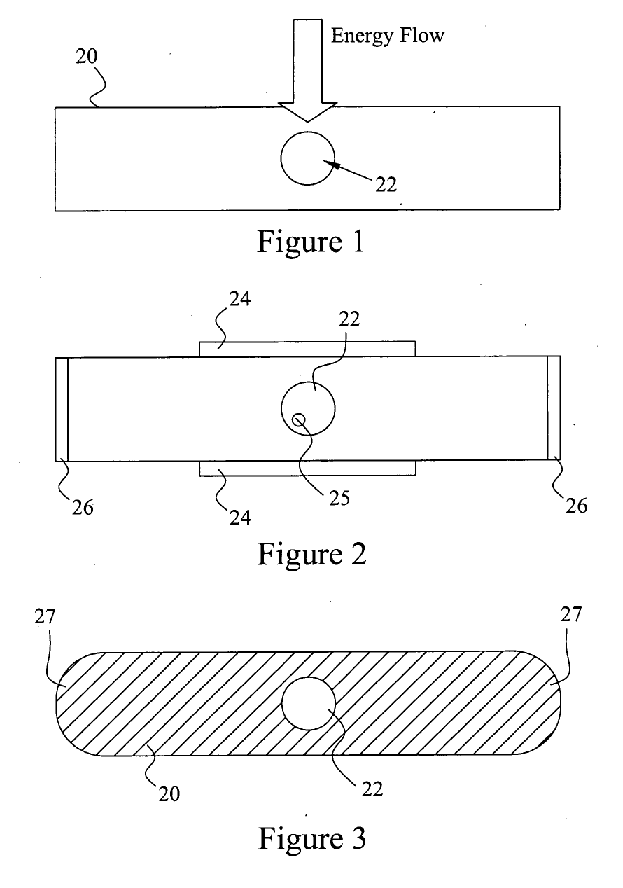

FIG. 1 is a schematic representation of an optical waveguide having an internal light source excited by the flow of energy through the waveguide in a direction normal to the axis of the waveguide.

FIG. 2 is a schematic illustration of the waveguide of FIG. 1 with a light reflecting coating on the waveguide in the area proximate to the source and a heat reflective (or fluorescent) coating on the ends of the area proximate to the source.

FIG. 3 is a schematic illustration of the waveguide of FIG. 1 with the ends of the waveguide shaped to control the distribution of light output.

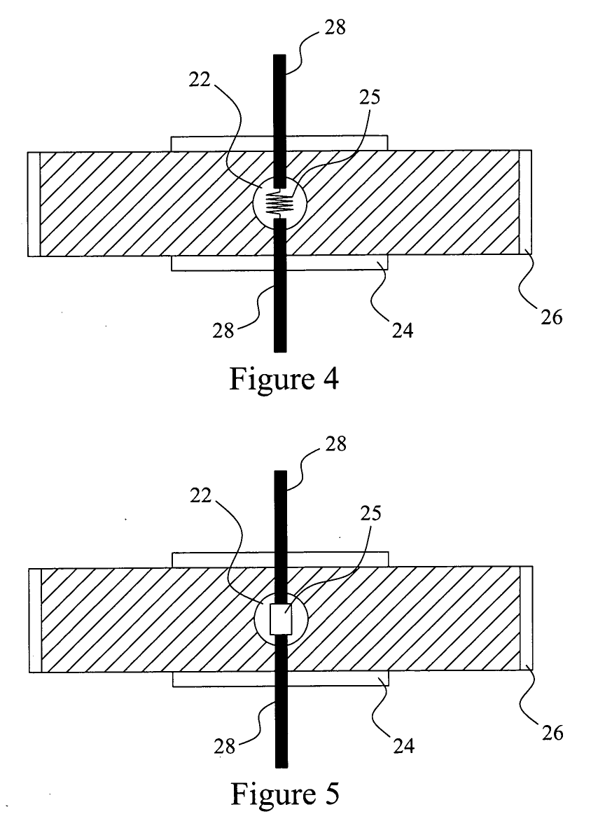

FIG. 4 is a schematic illustration of the embodiment of FIG. 3 with a filament source.

FIG. 5 is a schematic illustration of the embodiment of FIG. 3 with an LED source.

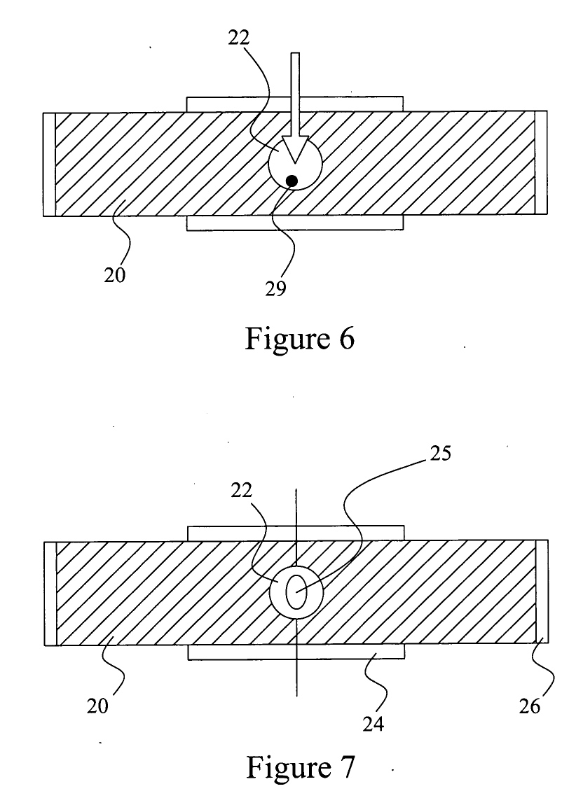

FIG. 6 is a schematic illustration of the embodiment of FIG. 3 with a fluorescent/phosphorescent source.

FIG. 7 is a schematic illustration of the embodiment of FIG. 3 with an electroded high intensity discharge (“HID”) source.

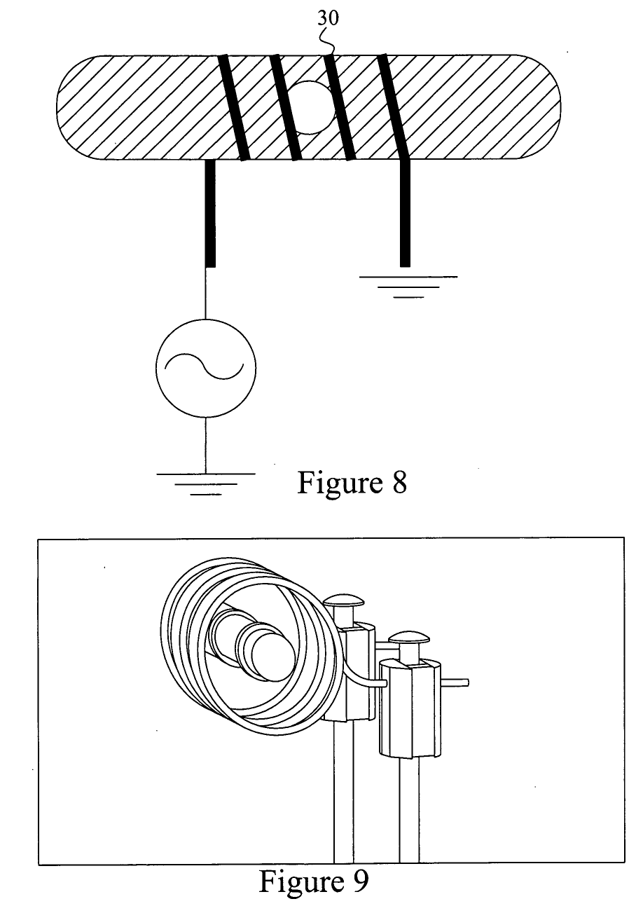

FIG. 8 is a schematic illustration of the embodiment of FIG. 3 with an electrodeless HID source.

FIG. 9 is a pictorial view of one embodiment of the system of FIG. 8 illustrating the inductive coupling of energy to the HID source.

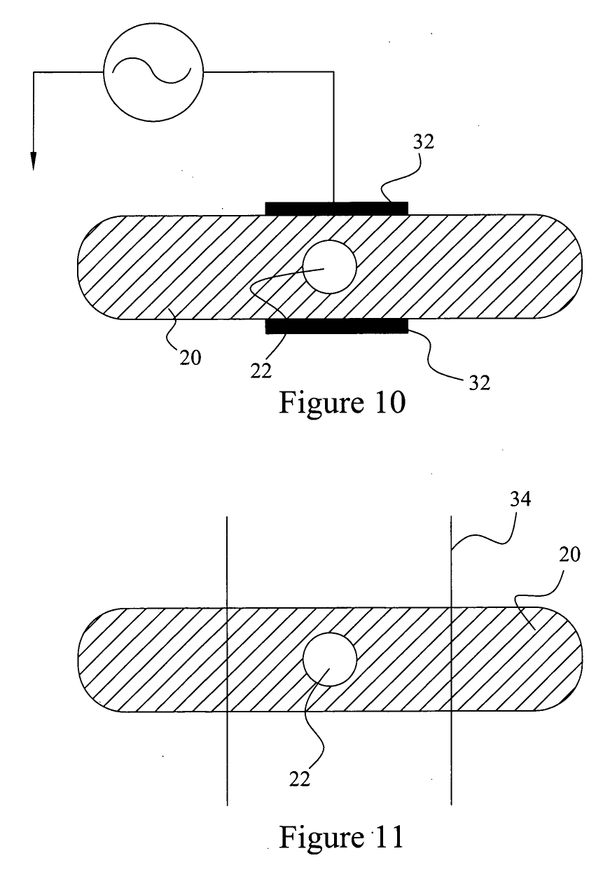

FIG. 10 is a schematic illustration of one embodiment of the system of FIG. 8 illustrating the capacitive coupling of energy to the HID source.

FIG. 11 is a schematic illustration of one embodiment of the system of FIG. 8 illustrating the coupling of energy to the source by a microwave cavity.

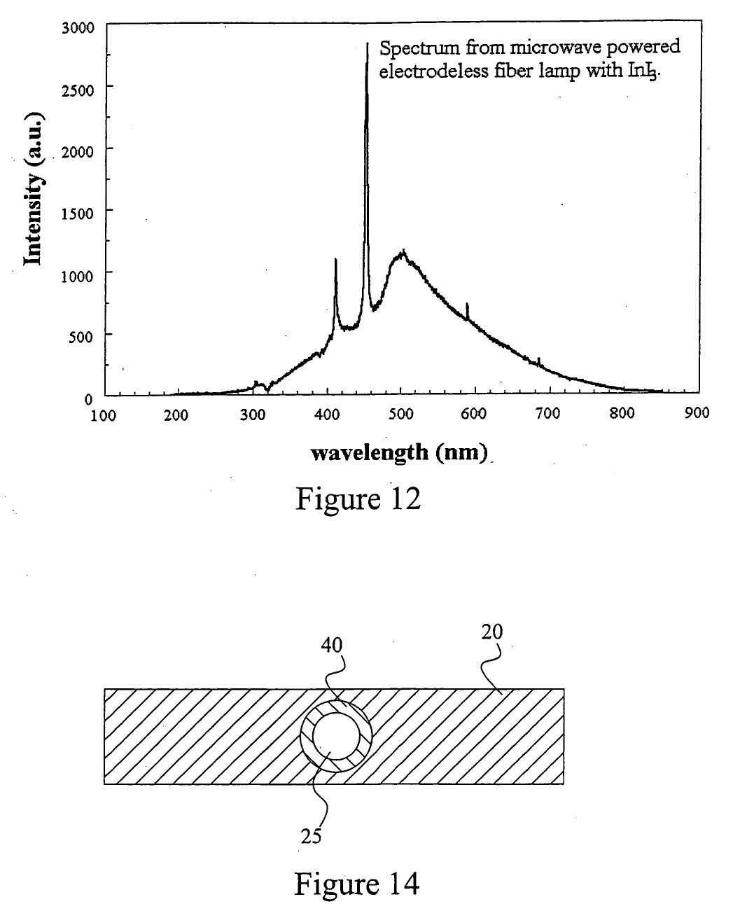

FIG. 12 is a graph of experimentally obtained data showing a plot of light intensity against the frequency of the exciting energy.

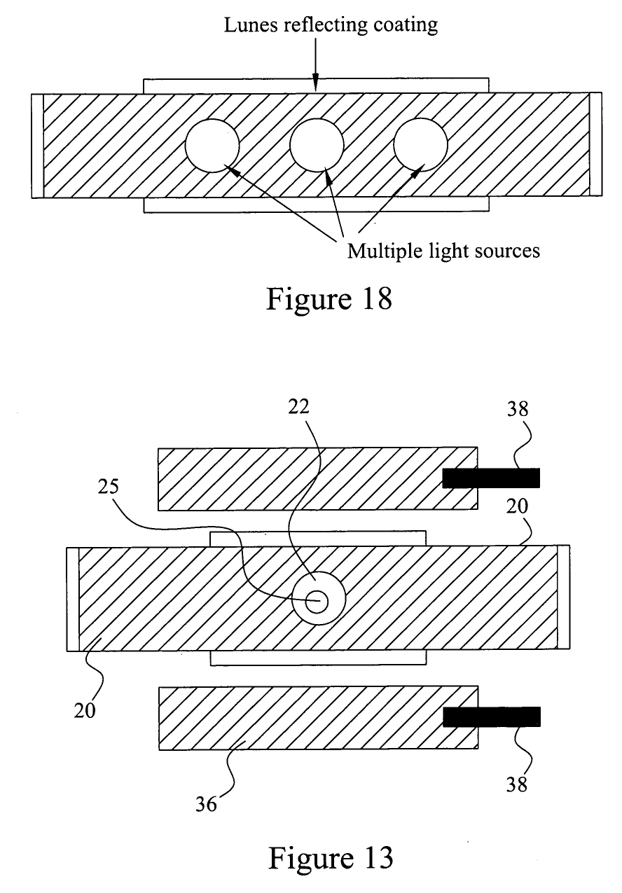

FIG. 13 is a schematic representation of the use of a microwave to power a light source that is integral with an optical waveguide.

FIG. 14 is a schematic illustration of the use of a buffer cavity between the source and the waveguide.

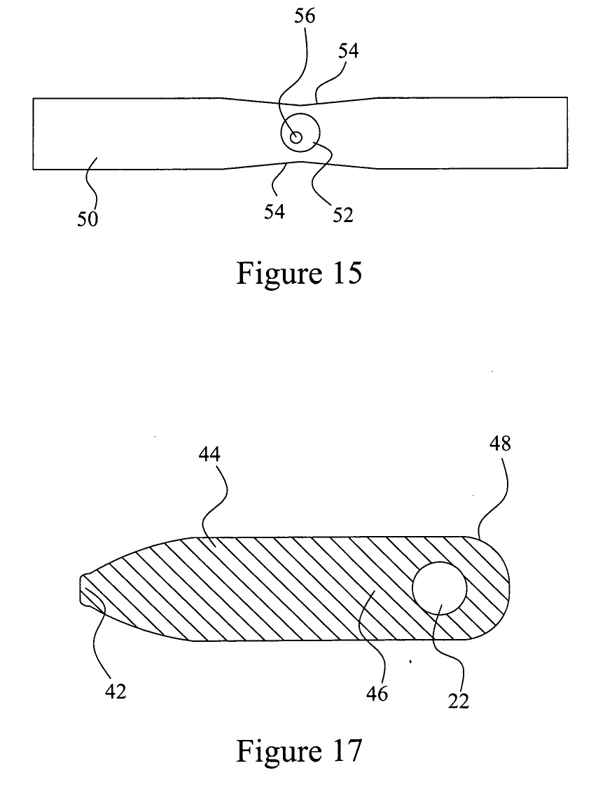

FIG. 15 is a schematic illustration of a waveguide shaped adjacent the source.

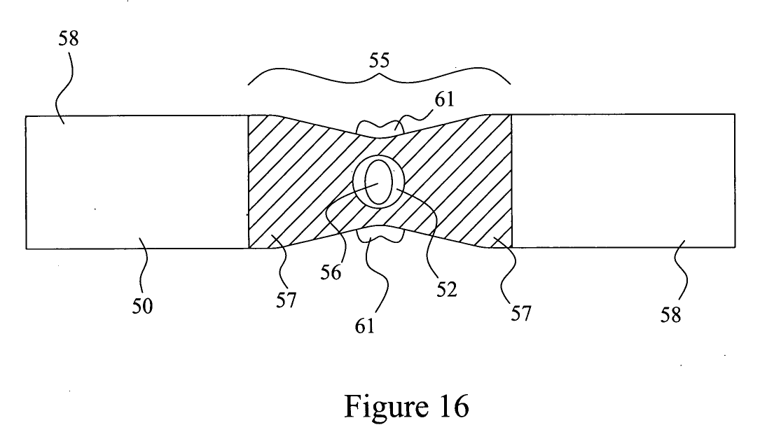

FIG. 16 is a schematic illustration of a waveguide shaped adjacent the source.

FIG. 17 is a schematic illustration of a source adjacent one end of a waveguide.

FIG. 18 is a schematic illustration of an embodiment with plural sources within the waveguide.

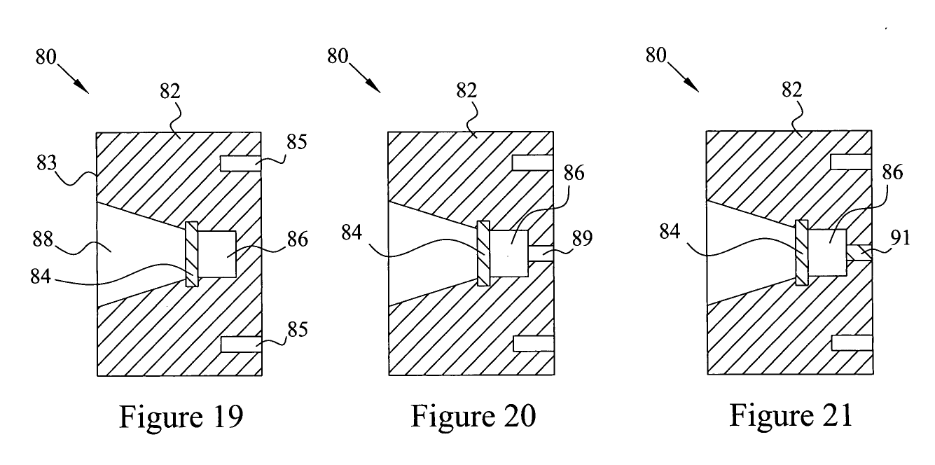

FIG. 19 is a schematic illustration of an integral light source, microwave waveguide and optical coupler.

FIGS. 20 and 21 are schematic illustrations of the integral light source, microwave waveguide, and optical coupler of FIG. 19.

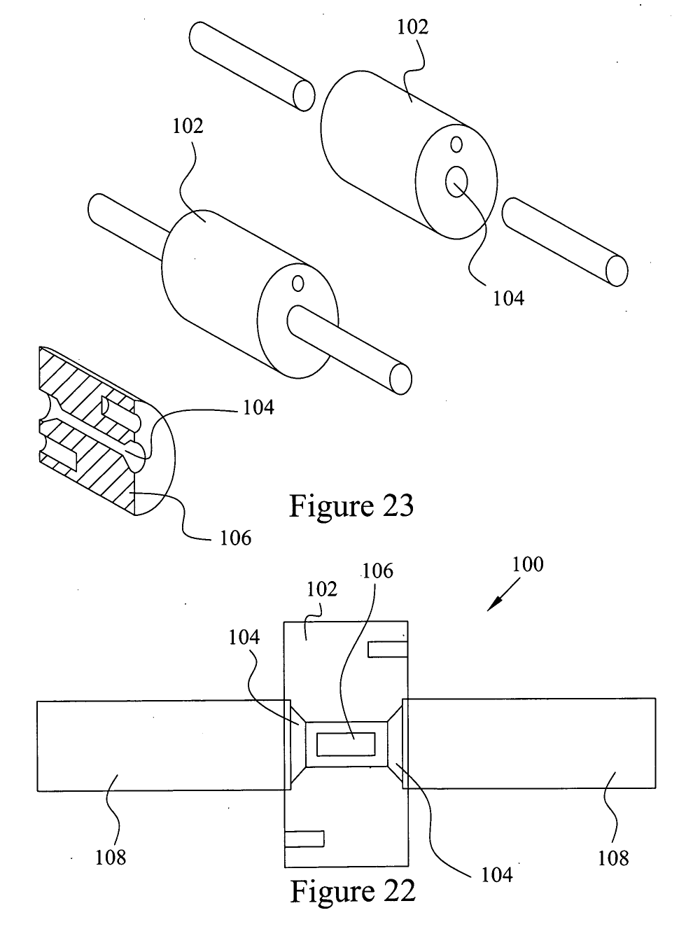

FIG. 22 is a schematic illustration of an embodiment of an integral light source, microwave waveguide and optical coupler.

FIG. 23 is a schematic illustration showing an exploded view of the device of FIG. 22.

### DESCRIPTION OF PREFERRED EMBODIMENTS

With reference to the embodiment of FIG. 1, a cylindrical optical waveguide 20 is shown with a cavity 22 positioned on the axis of the waveguide. The waveguide 20 may be made of quartz, ceramics such as Al₂O₃, transparent plastic or other material through which energy may flow into a source 25 positioned within the cavity 22 and through which light may transmitted. While only the area of the waveguide 20 that is proximate to the cavity 22 is illustrated in FIG. 1, it is to be understood that a further optical waveguide may be carried on both ends of such area as a continuation of the waveguide 20.

The energy for exciting the source 25 positioned within the cavity 22 may come from any suitable conventional source of electrical power, or from radiation such as RF, microwave, photons for another light source, gamma rays or cosmic rays, depending on the sourced selected. The light source 25 may be any suitable conventional source such as a discharge lamp, electroded or electrodeless, an incandescent lamp, tungsten filament or halogen lamp, a light emitting diode or LED, or fluorescent or phosphorous material. In other words, the source may be any means for converting energy into light for transmission through the optical waveguide 20.

In the present invention, the source 25 is physically located within the cavity 22 formed internally of the optical waveguide 20 so that the photons are mostly reflected by the internal reflection of the waveguide 20. The internal reflection of an optical waveguide is considerably better than any reflective coatings that may be applied to the external surface of the waveguide to prevent light from escaping. Where, however, the angle of incidence of the light on the boundary of the waveguide 20 is high as it is proximate to the source 25, it may be desirable to augment the internal reflection of the waveguide 20 with a reflecting coating 24 as shown in FIG. 2.

The waveguide 20 may be formed from material having a substantially uniform index of refraction. Alternatively, the index of refraction may vary from the axis of the waveguide to the outer surface of the waveguide to improve the focusing of light emitted from the source 25 and passing through the waveguide 20.

The light exiting the ends of the waveguide 20 may be reflected back into the waveguide by a reflective coating 26. For example, a reflective coating 26 may be used to reflect light at ultraviolet (“UV”) or infrared (“IR”) wavelengths while passing light in the visible spectrum. If, of course, light at a particular wavelength is desired, a suitable conventional coating may act as a band pass filter. The end coatings 26 may contain fluorescent materials to transform certain light (e.g. UV) into visible light (or IR).

The shape of the ends 27 of the waveguide 20 may be flat but may be shaped as illustrated in FIG. 3 to further control the output light distribution, such shaping being the equivalent of fusing an optical lens to the optical waveguide but substantially more robust and economical device.

An example of the system with an incandescent tungsten filament or halogen lamp as the source 25 is illustrated in FIG. 4. There, the source 25 is connected to a suitable source of energy applied to the source by electrodes 28. Other embodiments are illustrated in FIG. 5 where the source 25 is a LED, in FIG. 6 where fluorescent and/or phosphorous materials 29 inside the waveguide cavity 22 are excited by an external light source. Excitation may also be achieved by exposing the materials to a radioactive source material.

In FIG. 7 the source 25 is illustrated as an electroded HID device. HID sources provide a great deal of light relative to most other sources and the optical waveguide 20 serves as the shroud typically associated with such sources to protect against catastrophic failure of the HID source.

HID lamps may also be electrodeless as shown schematically in FIG. 8 and pictorially in FIG. 9. As illustrated, excitation may be achieved from an induction coil 30 surrounding the waveguide and its internal lamp. Such electrodeless excitation is generally preferable to the use of electrodes because the integrity of the waveguide is not compromised. In the illustrated embodiment, a generally cylindrical quartz waveguide having a diameter of about ⅝ inches and a length of about 4½ inches is positioned within an RF coil having a diameter of about 2 inches. The quartz waveguide includes an internal cavity that is dosed with a fill gas and metal halides and is excited by RF energy at 13.56 MHz.

HID lamps may also be excited by capacitive coupling through capacitor plates 32 as shown in FIG. 10. At lower frequencies, excitation can be accomplished with a dielectric barrier discharge. At higher frequencies, the displacement current is sufficient to carry the energy directly through the dielectric.

As schematically illustrated in FIG. 11, microwave energy may also be used to excite an electrodeless HID lamp. The microwave cavity 34 may be selected from a wide range of types such as rectangular metal, cylindrical metal, vane-structure cavity, traveling wave cavity, Evenson, rectangular dielectric, and cylindrical dielectric.

A transmission line type cavity has a cylindrical symmetry and the cavity needs to be tuned in resonance with the source. In addition, the cavity needs an impedance matching network to draw as much power from the source to the cavity as possible. Transmission line cavities may integrate both the tuning and impedance matching mechanism in the cavities and such known cavities can be modified to serve as an excitation cavity for the system described herein.

The transmission line type of microwave cavity may be of particular utility. In one experiment, the waveguide with the light source inserted therein was placed in the microwave cavity with the discharge chamber centered in the gap between hollow inner cylinders. The inner tunable cylinder was machined to fit snugly to the outer cylinder and the cavity was tuned by varying the gap distance between the inner cylinders. To obtain a good, uniform electrical connection between the outer conductor and the variable inner conductor, a TEFLON® tipped set screw was been added. Moreover, this screw acts to prevent detuning of the cavity by accidental movement of the variable inner cylinder. An adjustable matching stub was used to tune the impedance to 50 ohms.

As shown in FIG. 12, the intensity of the light from an InI₃ lamp peaked at approximately 2800 a.u. at a frequency of approximately 450 nanometers.

As shown in FIG. 13, a dielectric microwave waveguide may be used to both power the lamp as well as couple the light from the lamp into the optical waveguide. With reference to FIG. 13, an electrodeless lamp 25 positioned within the cavity 22 inside an optical waveguide 20 may be placed inside a dielectric microwave cavity 36 powered by a feed-through probe 38, e.g., by drilling a straight hole through the microwave cavity 36 and inserting the optical waveguide therein.

As shown in FIG. 14, the HID source 25 may be placed within a buffer cavity 40 within the optical waveguide 20. The used of a buffer cavity can provide further control over the wall temperature of the source by creating a thermal buffer layer. This can increase the wall temperature of the HID source and reduce the overall heat loss through conduction. The buffer cavity 40 may be filled with a gas selected for its ease in ionization so as to provide UV radiation, which in turn serves as a starting aid for the light source.

With reference to FIG. 15, the shape of the waveguide 50 may be modified to improve the light focusing characteristics of the waveguide. For example, the outer surface 54 of the waveguide may be compound parabolic extending axially toward each end from the center of the cavity 52. In this embodiment, the cross-sectional area of the waveguide 50 increases from the center of the cavity 52 toward the ends of the waveguide in such manner as to reduce the angle of light reflected from the surface as it passes from the source 25 toward each end of the waveguide.

With reference to FIG. 16, one embodiment includes the waveguide 50 having a central portion 55 intermediate generally cylindrical end portions 58. The central portion 55 includes opposing compound parabolic portions 57 surrounding the cavity 52. The light source 56 is positioned within the cavity 52 so that the light emitted from the source 56 will be internally reflected by the waveguide 50 toward the end portions 58. A reflective coating 61 may be formed on the surface of the waveguide 50 around the source 56 to reflect light emitted from the source 56 at large angles relative to the surface of the waveguide 50.

With reference to FIG. 17, where light output is desired from only one end 42 of the waveguide, the other end can be coated with a reflective coating 48.

As shown in FIG. 18, multiple light sources may be imbedded inside the optical waveguide to achieve higher lumens. More importantly, having multiple sources provides flexibility in balancing the lumens and the CRI thereby reducing the often very high requirement for the lamp physical and chemical performance. The light sources may be of completely different types, e.g. different LEDs can be used in conjunction with an HID lamp to achieve the correct CRI while satisfying the lumens requirement.

In yet another embodiment, a reflective coupler may be formed integrally with a dielectric waveguide integrated plasma lamp. With reference to FIG. 19, the device 80 comprises an integrated light source, microwave waveguide, and optical coupler. The device 80 includes a dielectric block 82. The block forms a microwave waveguide including microwave input and output probes 85. The block may be formed from material suitable for forming a microwave waveguide such as the ceramics alumina or zirconia. A cavity 81 is formed in the block 82 extending into the block from the surface 83. A light-transmitting window 84 is sealed over a portion of the cavity 81 forming a chamber 86. The light-transmitting window 84 may be formed from any suitable material such as sapphire. The portion of the cavity 81 extending from the window 84 to the surface 83 forms an optical coupler 88. The optical coupler 88 may be formed from any desirable shape such as parabolic or compound parabolic. The surface of the optical waveguide may include an optical coating (not shown) to improve reflectivity.

With reference to FIGS. 20 and 21, a bore 89 provides access to the interior of the chamber 86 for dosing the fill material for the plasma lamp. Once the fill materials are dosed into the chamber 86, the chamber may be sealed by plugging the bore 89 with a plug 91 of dielectric material and locally heating the plug and block material surrounding the plug using any suitable means such as laser. It may be necessary to submerge the block in water or liquid nitrogen to maintain proper temperature during the sealing process.

The lamp fill sealed in the chamber 86 may be illuminated by the application of microwave energy to the microwave waveguide formed by the block 82. The optical coupler 88 formed in the block 82 may then focus the light emitted from the chamber 86 into external optical waveguides such as light pipes or optical fibers. Thus the device 80 forms an integrated electrodeless plasma lamp, microwave waveguide, and optical coupler.

With reference to FIGS. 22 and 23, one embodiment 100 of an integrated electrodeless plasma lamp, microwave waveguide, and optical coupler includes a disc-shaped microwave dielectric block 102, a pair of compound parabolic optical couplers 104 formed along the axis of the disc 102, and an electrodeless plasma lamp 106 formed intermediate the optical couplers 104. The generally cylindrical optical waveguides 108 are coupled to the compound parabolic optical couplers 104 for transmission of the light emitted from the plasma lamp 106.

There are many advantages in placing the light source internally of the optical waveguide. The high coupling efficiency from the light source into the optical waveguide offers an integrated, compact and robust lamp and avoids the disadvantages of couplers. Such lamps can be used wherever there is a need to effectively bring an isotropic emitting light source into a need area and the applications include general lighting, projection lighting, automobile lighting, fiber illumination system, etc.

There are additional advantages in providing an integral light source, microwave waveguide, and optical coupler. This also provides a compact, robust lamp and obviates the deficiencies of having optical couplers that are not integral to the light source and microwave waveguide.

These and many other advantages will be apparent to one of skill in this art from a perusal of the foregoing description of preferred embodiments and the appended claims which are to be accorded a full range of equivalents.

What is claimed is:

1. An integrated optic system comprising a lamp and an optical waveguide, said lamp and said waveguide being directly coupled.
